(19) United States
(12) Patent Application Publication
(10) Pub. No.: US 2025/0354581 A1
(43) Pub. Date: Nov. 20, 2025

(54) PRELOAD NUT ASSEMBLY HAVING LOOSENING PREVENTION STRUCTURE AND WHEEL BEARING COMPRISING SAME

(71) Applicant: ILJIN GLOBAL Co.,Ltd, Seoul (KR)

(72) Inventor: Jong Keun LIM, Seoul (KR)

(73) Assignee: ILJIN GLOBAL Co.,Ltd, Seoul (KR)

(21) Appl. No.: 18/035,839

(22) PCT Filed: Nov. 5, 2021
(86) PCT No.: PCT/KR2021/016084

§ 371 Date: Nov. 7, 2023

(30) Foreign Application Priority Data
Nov. 6, 2020 (KR) 10-2020-0148130

(51) Int. Cl. F16C 25/08; B60B 27/00; B60B 27/02; F16C 19/18

(52) U.S. Cl. CPC F16C 25/083; F16C 19/183; B60B 27/0078; B60B 27/02; F16C 2326/02

(57) ABSTRACT

A preload nut assembly includes a preload nut having an inner circumferential surface in which a threaded portion is formed and threadedly coupled to the bearing device; a washer member coupled to the bearing device on one side of the preload nut; and a fastening clip configured to fasten the preload nut and the washer member. The preload nut may comprise at least one first flange which protrudes in a radially outward direction. The washer member may comprise a protrusion portion which protrudes in a radially inward direction on an inner circumferential surface thereof, and a body having a plurality of coupling holes formed to be spaced apart from each other along a circumferential direction. The fastening clip may comprise a fastening portion coupled to the first flange of the preload nut, and at least one axial extension portion inserted into the coupling hole of the washer member.

### CROSS-REFERENCE TO RELATED APPLICATIONS

This application is a national phase of International Application No. PCT/KR2021/016084 filed on Nov. 5, 2021, which claims priority to Korean Patent Application No. 10-2020-0148130 filed on Nov. 6, 2020, the entire contents of which are herein incorporated by reference.

### TECHNICAL FIELD

The present disclosure relates to a preload nut assembly used for applying a preload in a bearing device and a wheel bearing including the same, and more particularly to a preload nut assembly having an anti-loosening structure for preventing an unintended loosening of a preload nut to stably provide a preload required for a bearing device, and a wheel bearing including the same.

### BACKGROUND ART

A bearing is a part that rotatably supports a rotary element relative to a non-rotary element in a rotating device. A wheel bearing is used for rotatably mounting and supporting a wheel of a vehicle on a vehicle body.

In an example, a wheel bearing is configured such that a rotary element to which a wheel is mounted is connected to a non-rotary element fixed to a vehicle body via rolling elements and the wheel mounted on the rotary element is rotatably supported by the vehicle body.

Rolling bearings such as wheel bearings and the like are assembled while being applied with a preload to improve rigidity and performance and achieve lifespan extension. The application of such a preload is performed by, for example, a method of fastening a preload nut.

However, the preload nut fastened by screwing may undergo an unintended loosening due to vibration or the like generated during an operation. When such a loosening of the preload nut is generated, a bearing device does not remain in an appropriate preload state. This may reduce operational performance or lifespan.

### DISCLOSURE

### Technical Problem

The present disclosure was made to solve the above-mentioned matters, and the present disclosure is for the purpose of providing a preload nut assembly configured to prevent an unintended loosening of a preload nut to stably provide a preload required for a bearing device, and a wheel bearing including the same.

### Technical Solution

Representative configurations of the present disclosure to achieve the above objects are described below.

According to an aspect of the present disclosure, there is provided a preload nut assembly used to apply a preload to a bearing device. The preload nut assembly according to an example embodiment of the present disclosure may comprise: a preload nut having an inner circumferential surface in which a threaded portion is formed and threadedly coupled to the bearing device; a washer member coupled to the bearing device on one side of the preload nut; and a fastening clip configured to fasten the preload nut and the washer member. According to an example embodiment of the present disclosure, the preload nut may comprise at least one first flange which protrudes in a radially outward direction. According to an example embodiment of the present disclosure, the washer member may comprise a protrusion portion which protrudes in a radially inward direction on an inner circumferential surface thereof, and a body having a plurality of coupling holes formed to be spaced apart from each other along a circumferential direction. According to an example embodiment of the present disclosure, the fastening clip may comprise a fastening portion coupled to the first flange of the preload nut, and at least one axial extension portion inserted into the coupling hole of the washer member.

In an aspect of the present disclosure, the washer member may be configured such that the protrusion portion is inserted into and coupled to a corresponding recess formed to extend along an axial direction on an outer circumferential surface of the bearing device.

In an aspect of the present disclosure, the fastening portion of the fastening clip may be configured to be caught to an outer peripheral portion of the first flange of the preload nut.

In an aspect of the present disclosure, the fastening portion of the fastening clip may comprise an axial bent portion which is bent in the axial direction from a body portion, and a radial bent portion which is bent in the radially inward direction from an end of the axial bent portion, and the outer peripheral portion of the first flange of the preload nut may be inserted into and coupled to a space defined by the body portion, the axial bent portion, and the radial bent portion.

In an aspect of the present disclosure, the first flange of the preload nut may comprise a radial extension portion which extends in the radially outward direction and a coupling flange portion provided outside of the radial extension portion in a radial direction, and the fastening portion of the fastening clip may be configured to be coupled to the coupling flange portion.

In an aspect of the present disclosure, the coupling flange portion may be formed to have a width larger than a width of the radial extension portion.

In an aspect of the present disclosure, at least a portion of the axial extension portion of the fastening clip may be configured to be positioned inward of the coupling flange portion in the radial direction.

In an aspect of the present disclosure, a plurality of first flanges may be provided along the circumferential direction on an outer circumferential surface of the preload nut.

In an aspect of the present disclosure, the plurality of first flanges may be arranged at irregular intervals along the circumferential direction on the outer circumferential surface of the preload nut.

In an aspect of the present disclosure, the preload nut may comprise at least one second flange which protrudes in the radially outward direction from the outer circumferential surface of the preload nut to assist the coupling of the preload nut to the washer member.

In an aspect of the present disclosure, an end portion of the second flange in the radially outward direction may be bent in the axial direction to surround the outer circumferential surface of the washer member.

In an aspect of the present disclosure, the axial extension portion of the fastening clip may be provided on both end portions of the fastening clip in a width direction.

In an aspect of the present disclosure, the axial extension portion of the fastening clip may be formed to have a structure in which an end of the axial extension portion is bent.

In an aspect of the present disclosure, the axial extension portion of the fastening clip may be provided with an inner-surface protruded portion which protrudes inward in the width direction.

In another aspect of the present disclosure, there is provided a wheel bearing comprising the preload nut assembly described above.

Further, the preload nut assembly according to the present disclosure and the wheel bearing including the same may further comprise other additional configurations without departing from the technical sprit of the present disclosure.

### Advantageous Effects

A preload nut assembly according to an example embodiment of the present disclosure is configured such that a preload nut is coupled to a washer member fixed to a bearing device via a fastening clip. This makes it possible to prevent an unintended loosening from occurring in the preload nut during the operation of the bearing device, which stably provides a preload required for the bearing device.

### DESCRIPTION OF DRAWINGS

FIG. 1 exemplarily illustrates a wheel bearing in which a preload nut assembly according to an example embodiment of the present disclosure is mounted.

FIG. 2 exemplarily illustrates a structure of the preload nut assembly according to an example embodiment of the present disclosure.

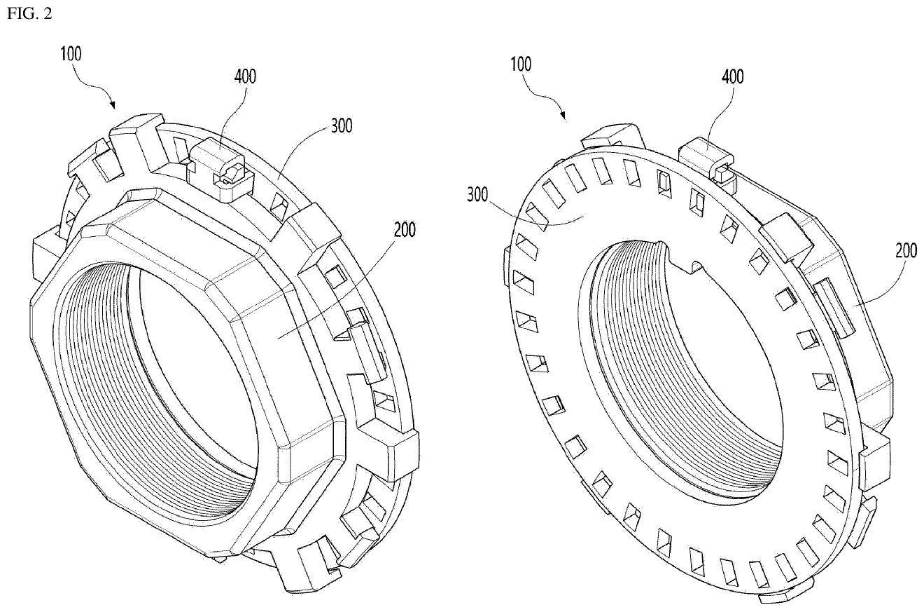

FIG. 3 exemplarily illustrates an exploded perspective view of the preload nut assembly according to an example embodiment of the present disclosure.

FIG. 4 exemplarily illustrates a preload nut of the preload nut assembly according to an example embodiment of the present disclosure.

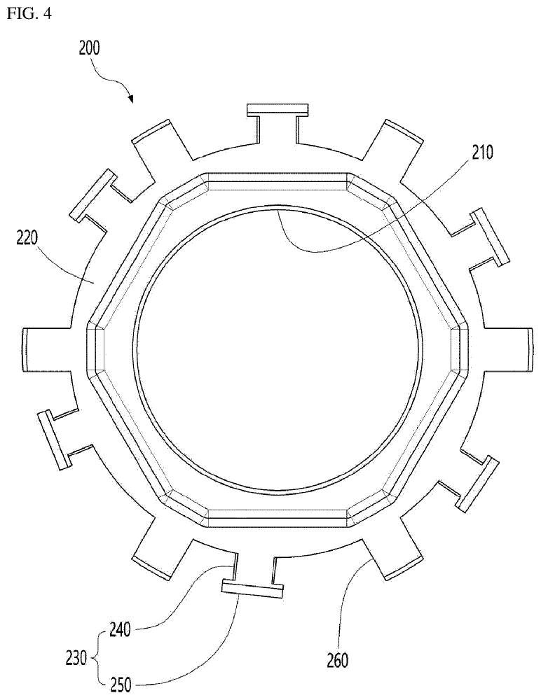

FIG. 5 exemplarily illustrates a washer member of the preload nut assembly according to an example embodiment of the present disclosure.

FIG. 6 exemplarily illustrates a fastening clip of the preload nut assembly according to an example embodiment of the present disclosure.

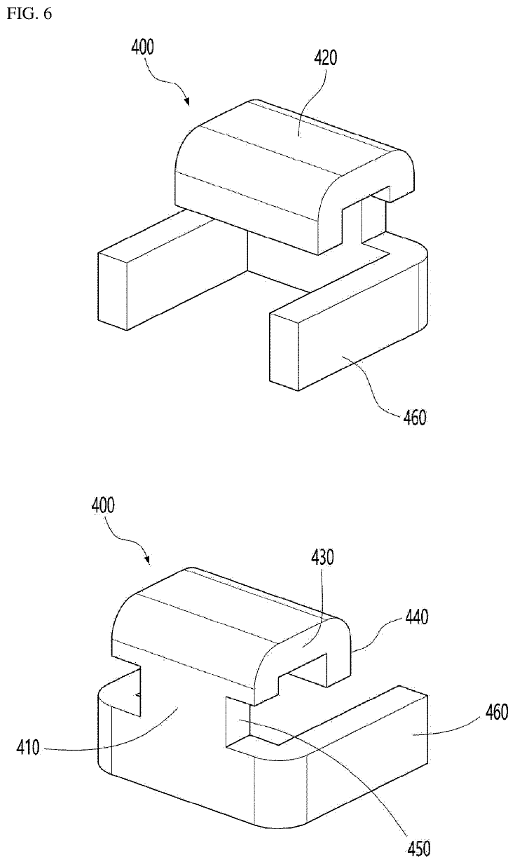

FIGS. 7A and 7B exemplarily illustrate modifications of the fastening clip of the preload nut assembly according to an example embodiment of the present disclosure.

### EXPLANATION OF REFERENCE NUMERALS

10: Wheel bearing (bearing device)
20: Rotary element
30: Non-rotary element
40: Rolling elements
100: Preload nut assembly
200: Preload nut
210: Threaded portion
220: Flange portion
230: First flange
240: Radial extension portion
250: Coupling flange portion
260: Second flange
270: Pad portion
300: Washer member
310: Protrusion portion
320: Coupling hole
400: Fastening clip
410: Body portion
420: Fastening portion
430: Axial bent portion
440: Radial bent portion
450: Recessed portion
460: Axial extension portion
470: Bent end portion
480: Inner-surface protrusion portion

### DETAILED DESCRIPTION

Example embodiments of the present disclosure are exemplified for the purpose of describing the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other example embodiments.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate descriptions of the same or corresponding constituent elements may be omitted. However, even though descriptions of any constituent element are omitted, such a constituent element is not intended to be excluded in any example embodiment.

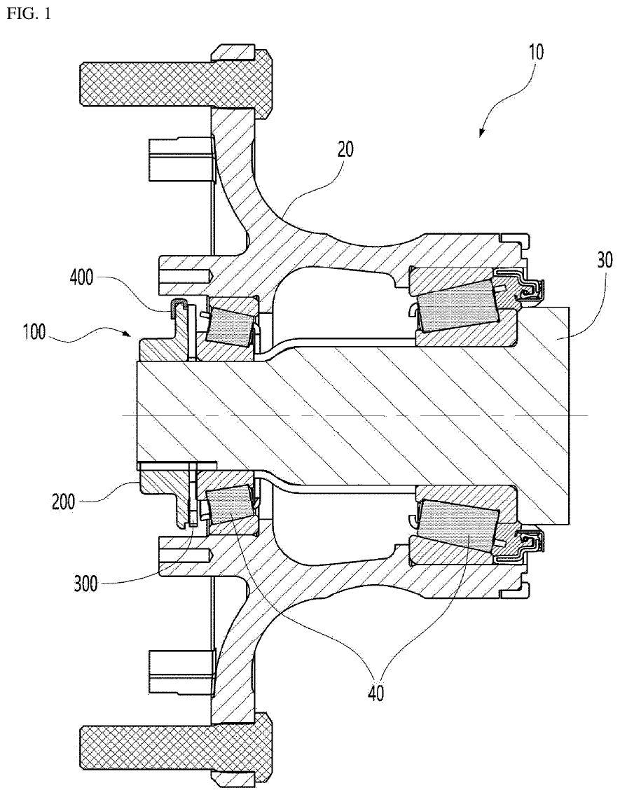

First, referring to FIG. 1, a structure of a wheel bearing 10 in which a preload nut assembly 100 according to an example embodiment of the present disclosure is mounted is exemplarily illustrated.

As illustrated in FIG. 1, the wheel bearing 10 is a device that rotatably mounts and supports a wheel of a vehicle on a vehicle body. The wheel bearing 10 may be configured such that a rotary element 20 on which the wheel of the vehicle is mounted is rotatably supported on a non-rotary element 30 fixed to the vehicle body via a plurality of rolling elements 40. The wheel bearing 10 may be configured such that one side thereof is threadedly coupled to a preload nut assembly 100 to be described below to hold the rolling elements 40 in a preset preload state.

However, in a case of the example embodiment illustrated in the drawing, a wheel bearing having a so-called first-generation structure with a preload nut assembly according to an example embodiment of the present disclosure is illustrated, but the preload nut assembly according to an example embodiment of the present disclosure is not necessarily used only in a bearing device with such a structure, and the preload nut assembly according to an example embodiment of the present disclosure may also be mounted and used in bearing devices with other various structures.

According to an example embodiment of the present disclosure, the preload nut assembly 100 may be configured to comprise a preload nut 200 threadedly coupled to a bearing device to apply a preload to the bearing, a washer member 300 coupled to one side of the preload nut 200, and a fastening clip 400 which fastens the preload nut 200 and the washer member 300.

According to an example embodiment of the present disclosure, the preload nut 200 may be coupled to one side of the bearing device (in the case of the example embodiment illustrated in the drawings, the preload nut 200 is configured to be coupled to an outer circumferential surface of a shaft member 30 located at a central portion of the wheel bearing 10) to perform a function of mounting and holding the rolling elements in a state where a preset preload is applied.

According to an example embodiment of the present disclosure, the preload nut 200 may be formed in a substantially cylindrical structure in which a central portion thereof is open. An inner circumferential surface of the preload nut 200 may be provided with a threaded portion 210. The threaded portion 210 may be threadedly coupled to a corresponding threaded portion formed in an outer circumferential surface of the bearing device (in the case of the example embodiment illustrated in the drawings, the threaded portion 210 is threadedly coupled to the corresponding threaded portion formed in the outer circumferential surface of the shaft member 30 of the wheel bearing 10).

According to an example embodiment of the present disclosure, the preload nut 200 may be provided with a flange portion 220 at an end portion facing the washer member 300. According to an example embodiment of the present disclosure, the flange portion 220 of the preload nut 200 may be configured to comprise a first flange(s) 230 for mounting of the fastening clip 400 and a second flange(s) 260 for assisting the coupling between the preload nut 200 and the washer member 300.

According to an example embodiment of the present disclosure, the first flange 230 may be formed in a structure protruding in a radially outward direction from the outer circumferential surface of the preload nut 200. According to an example embodiment of the present disclosure, at least one first flange, preferably a plurality of first flanges, may be provided on the outer circumferential surface of the preload nut 200 along a circumferential direction.

According to an example embodiment of the present disclosure, some or all of the plurality of first flanges 230 provided on the outer circumferential surface of the preload nut 200 may be formed at irregular intervals. In the case where the first flanges 230 are formed at irregular intervals in this way, when coupling holes 320 are formed at regular intervals in the washer member 300 to be described later, the preload nut 200 and the washer member 300 may be coupled to each other using the first flange 230 capable of being coupled to the fastening clip 400 among the plurality of first flanges 230.

According to an example embodiment of the present disclosure, the first flange 230 may be configured to comprise a radial extension portion 240 extending in the radially outward direction from an outer peripheral portion of the preload nut 200, and a coupling flange portion 250 provided outward of the radial extension portion 240 in a radial direction.

According to an example embodiment of the present disclosure, the coupling flange portion 250 provided outward of the radial extension portion 240 in the radial direction may be formed to have a width larger than a width of the radial extension portion 240. In this specification, a “width” direction refers to a direction perpendicular to an extension line extending from a central axis of the preload nut assembly toward the center of a respective member.

According to an example embodiment of the present disclosure, an edge portion between an outer circumferential surface of the coupling flange portion 250 and an axial end surface opposite to the washer member may be formed in an inclined structure to enhance the mounting property of the fastening clip 400.

According to an example embodiment of the present disclosure, the second flange 260 may be formed in the radially outward direction from the outer circumferential surface of the preload nut 200. One or more second flanges 260 may be provided on the outer circumferential surface of the preload nut 200 along a circumferential direction. For example, as illustrated in the drawing, a plurality of second flanges 260 may be provided at regular intervals on the outer circumferential surface of the preload nut 200 along the circumferential direction.

According to an example embodiment of the present disclosure, an end portion of the second flange 260 in the radially outward direction may be provided with a pad portion 270 which is bent toward the washer member 300 in an axial direction, and may be configured to surround an outer circumferential surface of the washer member 300 through the pad portion 270.

According to an example embodiment of the present disclosure, the outer circumferential surface of the preload nut 200 may be formed in a cylindrical shape as a whole. The preload nut 200 may be formed to have a polygonal cross-sectional structure such that a holding capability of the preload nut 200 is improved when the preload nut 200 is threadedly coupled to the bearing device. For example, in the case of an example embodiment illustrated in the drawings, a portion of the outer circumferential surface of the preload nut 200 may have a cross-sectional structure of an approximately hexagonal shape to improve the holding capability of the preload nut 200 when the preload nut 200 is threadedly coupled to the bearing device.

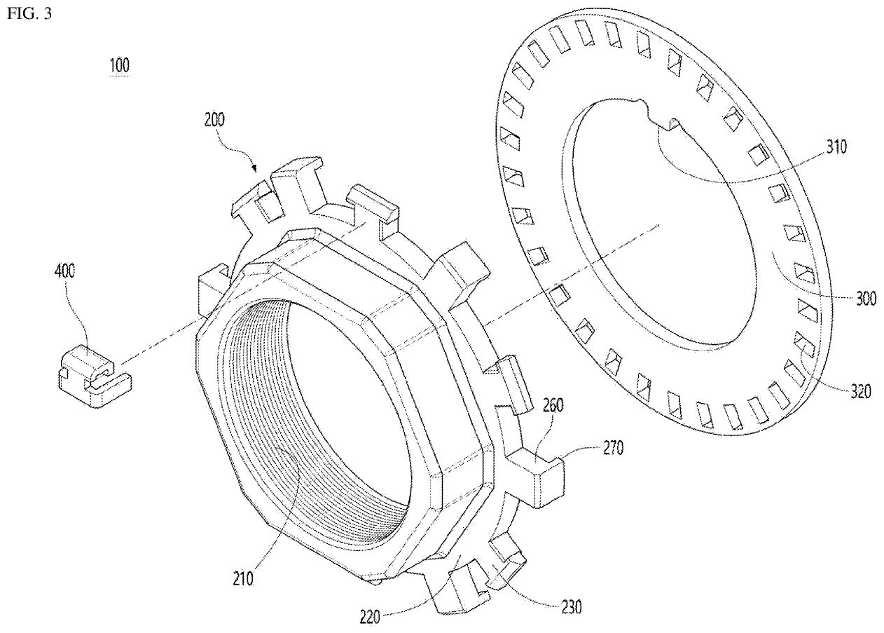

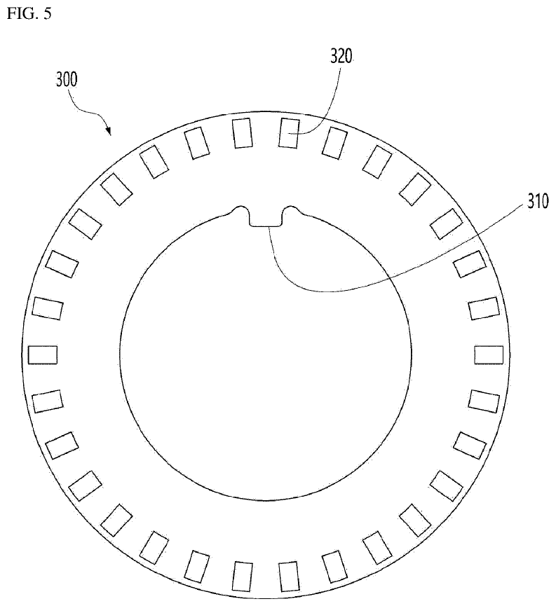

According to an example embodiment of the present disclosure, as illustrated in FIGS. 3 and 5, the washer member 300 may be formed in a substantially ring-shaped structure in which a central portion thereof is open, and may be coupled to the bearing device at one side of the preload nut 200.

According to an example embodiment of the present disclosure, the washer member 300 may comprise a protrusion portion 310 which protrudes in the radially inward direction on the inner circumferential surface of the washer member 300. The washer member 300 may be configured such that the protrusion portion 310 is inserted into and coupled to a corresponding recess which is formed to extend along the axial direction on the outer circumferential surface of the bearing device (specifically, a member to which the washer member 300 is coupled in the bearing device; in the case of the example embodiment illustrated in the drawings, the shaft member 30 to which the washer member 300 is coupled). By such a coupling, the washer member 300 may be configured to rotate integrally with a corresponding member of the bearing device to which the washer member 300 is coupled.

According to an example embodiment of the present disclosure, the washer member 300 may be configured such that a plurality of coupling holes 320 are formed to be spaced apart from each other along the circumferential direction in a body. For example, the coupling holes 320 may be formed as through-holes of penetrating the washer member 300. An axial extension portion 460 of the fastening clip 400 described below may be inserted into and coupled to the coupling hole 320.

According to an example embodiment of the present disclosure, the fastening clip 400 may perform a function of coupling the preload nut 200 and the washer member 300 and causing the preload nut 200 to rotate together with the washer member 300 (that is, a function of preventing the preload nut 200 from rotating relative to the washer member 300).

According to an example embodiment of the present disclosure, the fastening clip 400 may be configured to comprise a fastening portion 420, which is coupled to the first flange 230 of the preload nut 200, at one side of the body portion 410, and at least one axial extension portion 460 which extends in the axial direction from the body portion 410 to be inserted into and coupled to the coupling hole 320 of the washer member 300.

For example, according to an example embodiment of the present disclosure, the fastening clip 400 may be formed by bending one portion of a metal plate to form the fastening portion 420 and then bending another portion of the metal plate to form the axial extension portion(s) 460.

According to an example embodiment of the present disclosure, the fastening portion 420 of the fastening clip 400 may be configured to comprise an axial bent portion 430 which is bent in the axial direction from the body portion 410, and a radial bent portion 440 which is bent in the radially inward direction from an end of the axial bent portion 430. An outer peripheral portion of the first flange 230 of the preload nut 200 may be inserted into and coupled to a space defined by the body portion 410, the axial bent portion 430 and the radial bent portion 440.

That is, according to an example embodiment of the present disclosure, the fastening portion 420 of the fastening clip 400 may be configured to surround the first flange 230 of the preload nut 200 in the radially outward direction.

Further, according to an example embodiment of the present disclosure, the body portion 410 of the fastening clip 400 may comprise a recessed portion 450 formed to extend inward in the width direction.

According to an example embodiment of the present disclosure, the axial extension portion 460 of the fastening clip 400 may be provided on each of both end portions of the fastening clip 400 in the width direction.

According to an example embodiment of the present disclosure, a plurality of axial extension portions 460 may be provided to be spaced apart from each other along the width direction of the fastening clip 400 such that they are inserted into and coupled to the coupling holes 320 of the washer member 300. For example, in the case of the example embodiment illustrated in the drawings, the axial extension portions 460 may be provided on both end portions of the fastening clip 400 in the width direction, respectively.

According to an example embodiment of the present disclosure, a widthwise length between the axial extension portions 460 provided on the both end portions of the fastening clip 400 in the width direction may be set to be greater than a widthwise length of the radial extension portion 240 constituting the first flange 230 and to be smaller than a widthwise length of the coupling flange portion 250 constituting the first flange 230.

With this configuration, the fastening clip 400 according to an example embodiment of the present disclosure may be designed such that at least a portion of the axial extension portion 460 of the fastening clip 400 is positioned inward of the coupling flange portion 250 of the first flange 230 in the radial direction when being coupled to the first flange 230 of the preload nut 200, thus suppressing the fastening clip 400 from moving in the radially outward direction by the coupling flange portion 250.

Thus, by mounting the fastening clip 400 to surround the first flange 230 of the preload nut 200 in the radially outward direction by the fastening portion 420, it is possible to suppress the axial extension portion 460 from moving in the radially outward direction by the coupling flange portion 250 of the first flange 230, which ensures more stable coupling between the preload nut 200 and the washer member 300.

According to an example embodiment of the present disclosure, the axial extension portion(s) 460 of the fastening clip 400 may be provided such that the end portion thereof is inserted into and coupled to the coupling hole 320 of the washer member 300. This makes it possible to prevent the preload nut 200 from rotating in an unintended manner.

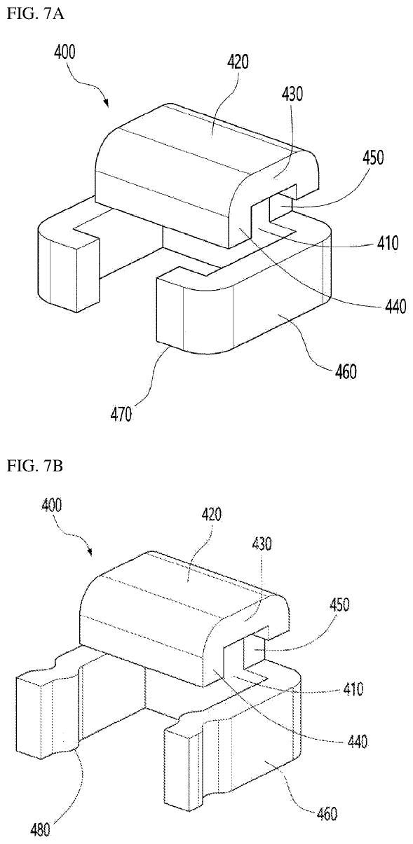

According to an example embodiment of the present disclosure, as illustrated in FIG. 7A, in order to enhance the coupling property between the fastening clip 400 and the washer member 300, the axial extension portion 460 of the fastening clip 400 may be formed to have a structure in which an end thereof is bent. Alternatively, as illustrated in FIG. 7B, in order to enhance the coupling property between the fastening clip 400 and the washer member 300, the axial extension portion 460 of the fastening clip 400 may be formed to have an inner-surface protrusion portion 480 formed to protrude inward from an inner surface of the axial extension portion 460 in the width direction.

In the preload nut assembly 100 configured as above according to an example embodiment of the present disclosure, when the washer member 300 is coupled to the bearing device, the protrusion portion 310 formed on the inner circumferential surface of the washer member 300 is inserted into and coupled to the corresponding recess formed along the axial direction on the outer circumferential surface of the bearing device (in the case of the example embodiment illustrated in the drawings, the outer circumferential surface of the shaft member 30 to which the washer member 300 is coupled). This makes it possible to prevent the washer member 300 from rotating beyond a certain range relative to a corresponding member of the bearing device. In this state, the preload nut 200 is fastened to the washer member 300 by the fastening clip 400. Thus, the preload nut 200 may be prevented from rotating beyond the certain range relative to the washer member 300. This makes it possible to prevent an unintended loosening of the preload nut 200 with respect to the bearing device, thus holding the bearing device in a proper preload state.

Although the present disclosure has been described above in terms of specific items such as detailed constituent elements as well as the limited example embodiments, they are merely provided to help more general understanding of the present disclosure, and the present disclosure is not limited to the above example embodiments. Various modifications and changes could have been realized by those skilled in the art to which the present disclosure pertains from the above descriptions.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

1. A preload nut assembly used for applying a preload to a bearing device, the preload nut assembly comprising:
a preload nut having an inner circumferential surface in which a threaded portion is formed and threadedly coupled to the bearing device;
a washer member coupled to the bearing device on one side of the preload nut; and
a fastening clip configured to fasten the preload nut and the washer member,
wherein the preload nut comprises at least one first flange which protrudes in a radially outward direction,
wherein the washer member comprises a protrusion portion which protrudes in a radially inward direction on an inner circumferential surface thereof, and a body having a plurality of coupling holes formed to be spaced apart from each other along a circumferential direction, and
wherein the fastening clip comprises a fastening portion coupled to the first flange of the preload nut, and at least one axial extension portion inserted into the coupling hole of the washer member.

2. The preload nut assembly of claim 1, wherein the washer member is configured such that the protrusion portion is inserted into and coupled to a corresponding recess formed to extend along an axial direction on an outer circumferential surface of the bearing device.

3. The preload nut assembly of claim 2, wherein the fastening portion of the fastening clip is configured to be caught to an outer peripheral portion of the first flange of the preload nut.

4. The preload nut assembly of claim 3, wherein the fastening portion of the fastening clip comprises an axial bent portion which is bent in the axial direction from a body portion, and a radial bent portion which is bent in the radially inward direction from an end of the axial bent portion, and
wherein the outer peripheral portion of the first flange of the preload nut is inserted into and coupled to a space defined by the body portion, the axial bent portion, and the radial bent portion.

5. The preload nut assembly of claim 4, wherein the first flange of the preload nut comprises a radial extension portion which extends in the radially outward direction and a coupling flange portion provided outside of the radial extension portion in a radial direction, and
wherein the fastening portion of the fastening clip is configured to be coupled to the coupling flange portion.

6. The preload nut assembly of claim 5, wherein the coupling flange portion is formed to have a width larger than a width of the radial extension portion.

7. The preload nut assembly of claim 6, wherein at least a portion of the axial extension portion of the fastening clip is configured to be positioned inward of the coupling flange portion in the radial direction.

8. The preload nut assembly of claim 7, wherein a plurality of first flanges are provided along the circumferential direction on an outer circumferential surface of the preload nut.

9. The preload nut assembly of claim 8, wherein the plurality of first flanges are arranged at irregular intervals along the circumferential direction on the outer circumferential surface of the preload nut.

10. The preload nut assembly of claim 8, wherein the preload nut comprises at least one second flange which protrudes in the radially outward direction from the outer circumferential surface of the preload nut to assist the coupling of the preload nut to the washer member.

11. The preload nut assembly of claim 10, wherein an end portion of the second flange in the radially outward direction are bent in the axial direction to surround the outer circumferential surface of the washer member.

12. The preload nut assembly of claim 11, wherein the axial extension portion of the fastening clip is provided on both end portions of the fastening clip in a width direction.

13. The preload nut assembly of claim 12, wherein the axial extension portion of the fastening clip is formed to have a structure in which an end of the axial extension portion is bent.

14. The preload nut assembly of claim 12, wherein the axial extension portion of the fastening clip is provided with an inner-surface protruded portion which protrudes inward in the width direction.

15. A wheel bearing comprising the preload nut assembly of claim 1.
